(19) United States
(12) Patent Application Publication
(10) Pub. No.: US 2007/0257469 A1
(43) Pub. Date: Nov. 8, 2007

(54) VERTICALLY AND HORIZONTALLY LOADING TRAILER LATCHING ASSEMBLY

(76) Inventors: David J. Burns, Draper, UT (US); Erik M. Mumford, Sandy, UT (US)

Correspondence Address: Kunzler & McKenzie, 8 EAST BROADWAY, SUITE 600, SALT LAKE CITY, UT, 84111, US

(21) Appl. No.: 11/744,586

(22) Filed: May 4, 2007

Related U.S. Application Data
(60) Provisional application No. 60/746,590, filed on May 5, 2006.

(51) Int. Cl. B62D 53/06

(52) U.S. Cl. 280/433

(57) ABSTRACT

A hitch is disclosed for vertical and horizontal loading of a trailer latching device. The hitch includes a locking extension positionable to interface with a lesser diameter portion of a coupling member to prevent vertical movement of the coupling member. The hitch also includes a cup comprising an at least partially arcuate sidewall positionable to interface with a greater diameter portion of the coupling member to prevent horizontal coupling member movement. Linkage coordinates relative movement of the locking extension and the cup such that the coupling member is receivable into lockable engagement with the hitch upon either vertical or horizontal movement of the coupling member relative to the hitch.

### CROSS-REFERENCES TO RELATED APPLICATIONS

This application is a continuation-in-part of and claims priority to U.S. Provisional Patent Application No. 60/746,590 entitled “VERTICALLY AND HORIZONTALLY LOADING FIFTH WHEEL HITCH ASSEMBLY” and filed on May 5, 2006 for David J. Burns and Erik M. Mumford which is incorporated herein by reference.

### BACKGROUND OF THE INVENTION

1. Field of the Invention

The present invention relates generally to towing devices and, more particularly, to a fifth wheel hitch configured for vertical and horizontal loading.

2. Description of the Related Art

Fifth wheel hitches have been used for decades to tow a trailer behind a vehicle. Conventional fifth wheel hitches typically include a support frame for mounting the hitch to the towing vehicle, such as, for example, to a bed of a pickup truck and a head assembly which includes the mechanism for attaching the hitch assembly to a king pin of the fifth wheel trailer.

The support frame or conventional fifth wheel hitches often includes a pair of base rails that are bolted to the bed and or frame of the truck, side brackets that are releasably mounted to the base rails and a head support mounted to the side brackets. The head assembly is mounted to the head support by means of a trunnion arrangement allowing for pivotal fore-and-aft movement relative to the side brackets.

For fifth wheel hitches designed to couple to a king pin-type fifth wheel, the head assembly includes a jaw assembly operable by means of a control handle. The jaw assembly is specifically adapted to releasably engage and hold the kingpin of the trailer.

Conventional fifth wheel trailer hitches are typically centered over the axles of the rear wheels of towing vehicle so as to place the tongue-weight of the vehicle over the rear tires. This results in a desired weight positioning of the trailer relative to the towing vehicle for traveling at highway speeds.

Unfortunately, current fifth wheel hitches are often difficult to connect to fifth wheel trailers. Great care must be taken to ensure that as a trucks backs up to a fifth wheel trailer the hitch is at the correct height. Fifth wheel hitches must approach kingpins at substantially the same height as the kingpin. The margin for error is small, on the order of inches. Often, the hitch is too high or too low for the kingpin. If the hitch is too high it may appear to the driver of the truck that a proper coupling has occurred between the kingpin and the hitch, even though it has not. This situation is extremely unsafe and may lead to the uncoupling of the trailer, and severe damage to the truck, trailer, driver, and passengers.

Accordingly, there exists a need in the relevant art to provide a fifth wheel hitch that is capable of securely coupling to a kingpin during a vertical and horizontal approach. Furthermore, there exists a need in the relevant art to provide a fifth wheel hitch that is capable pf overcoming the disadvantages of the prior art.

### SUMMARY OF THE INVENTION

From the foregoing discussion, it should be apparent that a need exists for an improved hitch. The present invention has been developed in response to the present state of the art, and in particular, in response to the problems and needs in the art that have not yet been fully solved by currently available hitches. Accordingly, the present invention has been developed to provide a hitch that overcomes many or all of the above-discussed shortcomings in the art.

In one embodiment, the hitch includes a locking extension positionable to interface with a lesser diameter portion of a coupling member to prevent vertical movement of the coupling member, a cup comprising an at least partially arcuate sidewall positionable to interface with a greater diameter portion of the coupling member to prevent horizontal coupling member movement, and a linkage coordinating relative movement of the locking extension and the cup such that the coupling member is receivable into lockable engagement with the hitch upon either vertical or horizontal movement of the coupling member relative to the hitch.

The hitch also includes a ramp pivotally coupling the cup with a shroud, a bar coupled with the ramp and configured to transfer pivotal movement of the ramp with the locking extension, and a handle coupled with the locking extension and configured to release the coupling member. In a further embodiment, the cup comprises a surface configured to receive the larger diameter portion of the coupling member, and the locking extension comprises a surface configured to receive the smaller diameter portion of the coupling member. In one embodiment, the surface is integrally formed in a cam, the smaller diameter portion of the coupling member comprises a shank of a kingpin, and the larger diameter potion of the coupling member comprises a head of a kingpin.

A method of the present invention is also included. In one embodiment, the method comprises positioning and interfacing a locking extension with a lesser diameter portion of a coupling member to prevent vertical movement of the coupling member, positioning a cup comprising an at least partially arcuate sidewall and to interfacing with a greater diameter portion of the coupling member to prevent horizontal coupling member movement, and coordinating relative movement of the locking extension and the cup such that the coupling member is receivable into lockable engagement with the hitch upon either vertical or horizontal movement of the coupling member relative to the hitch.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective view diagram illustrating a fifth wheel trailer 100 connected to a pickup truck using a fifth wheel hitch 104 in accordance with the prior art;

FIG. 2 is a perspective view diagram illustrating one embodiment of a hitch capable of horizontal and vertical loading in accordance with the present invention

FIG. 3a is a perspective view diagram illustrating one embodiment of a hitch shown in a closed position in accordance with the present invention;

FIG. 3b is a perspective view diagram illustrating the hitch of FIG. 3a shown in an open position in accordance with the present invention;

FIG. 4 is a side perspective view diagram illustrating one embodiment of the shroud in accordance with the present invention;

FIGS. 5a and 5b are perspective view diagrams illustrating a partial view of the hitch in accordance with the present invention;

FIGS. 6a and 6b are schematic block diagrams illustrating an alternative partial view of the hitch in accordance with the present invention;

FIG. 7 is a perspective view diagram illustrating one embodiment of a jaw mechanism in accordance with the present invention;

FIGS. 8a and 8b are bottom perspective view diagrams illustrating embodiments of the locking extension interaction with the lever in accordance with the present invention;

FIG. 9a is a schematic block diagram illustrating one embodiment of a cross section of a kingpin in accordance with the present invention;

FIG. 9b is a cross-section diagram illustrating one embodiment of a ball hitch in accordance with the present invention;

FIG. 10a is a cross-section diagram illustrating an alternative embodiment of a hitch in accordance with the present invention;

FIG. 10b is a cross-section diagram illustrating another embodiment of the hitch in accordance with the present invention;

FIGS. 11a and 11b are side view diagrams illustrating alternative embodiments of the shroud in accordance with the present invention;

FIG. 12 is a perspective view diagram illustrating one embodiment of the cam and cup in accordance with the present invention; and

FIG. 13 is a schematic flow chart diagram illustrating one embodiment of a method for operating the hitch in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to give a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

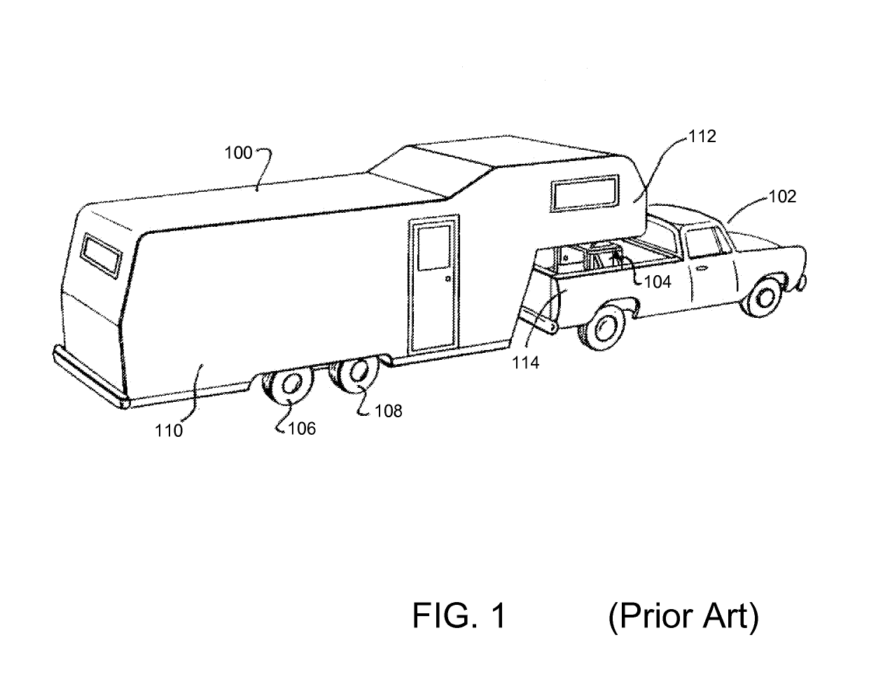

FIG. 1 is a perspective view illustrating a fifth wheel trailer 100 connected to a pickup truck 102 using a fifth wheel hitch (hereinafter “hitch”) 104 in accordance with the prior art. Fifth wheel trailers 100 may include one or more axles, and in the depicted embodiment, include tandem axles having front and rear wheels 106, 108. The wheels 106, 108 together with the axles support a body 110 having a forward portion 112 that projects over a bed 114 of the truck.

The forward portion 112 generally includes a downwardly projecting support system that connects to the hitch 104 of the truck 102. The support system typically includes a protruding male portion referred to herein as a coupling member. In one embodiment, the coupling member is formed in the shape of a cylinder referred to as a “kingpin” that engages a jaw mechanism of the hitch 104. The kingpin must engage the jaw mechanism of prior art hitches in such a way as to create a secure connection. Of course, other types of coupling members may be used. For instance, the coupling member may also be a ball such as is used in a ball hitch. The embodiment in which a king pin is used will be described hereafter as an example of the invention, but one skilled in the art will readily recognize the manner in which other types of coupling members may be substituted.

In order to create a secure connection, the driver of the truck 102 must “back-up” the truck towards the trailer 110 and ensure that the hitch is at the same horizontal elevation as the kingpin. Aligning the hitch 104 with the kingpin is often a difficult task without having to worry about the correct horizontal elevation. Unfortunately, truck drivers often lower the kingpin into the hitch instead of horizontally sliding the kingpin into the hitch 104. A vertical loading of the kingpin results in an improper coupling of the kingpin and hitch 104, and the trailer may become disconnected from the hitch 104 and subsequently the truck 102.

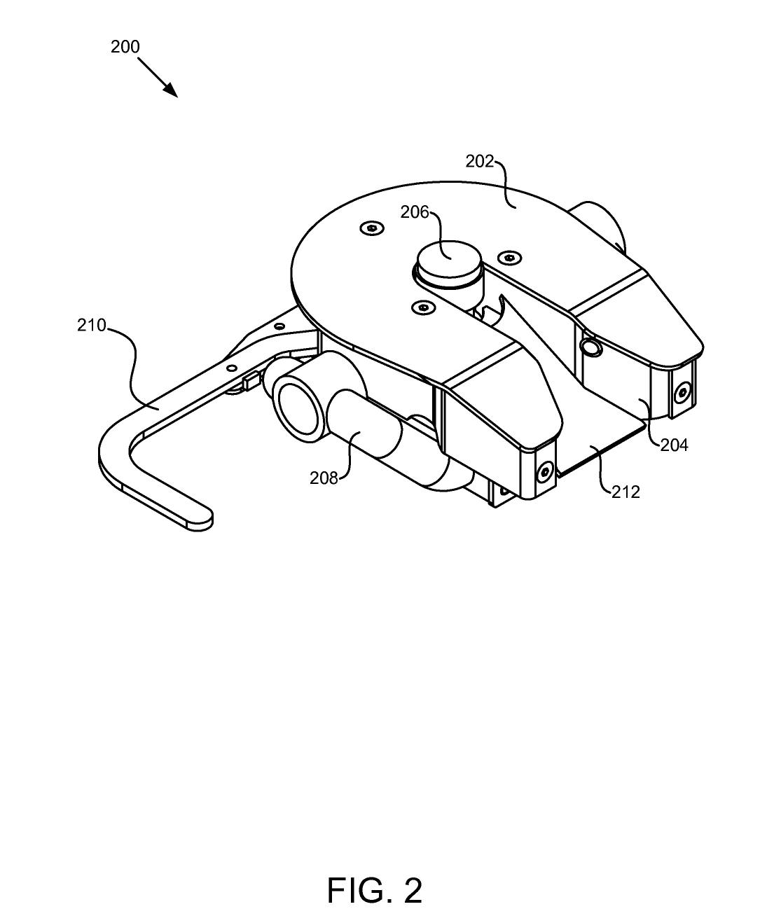

FIG. 2 is a perspective view illustrating one embodiment of a fifth wheel hitch 200 capable of horizontal and vertical loading in accordance with the present invention. In one embodiment, the fifth wheel hitch (hereinafter “hitch”) 200 comprises a cover plate 202 removably coupled with a shroud 204. The shroud 204, as depicted, is in the general shape of a horseshoe and is configured to receive and connect with a kingpin 206 of the trailer 110 of FIG. 1.

The hitch 200 may be connected with the bed of a truck 102 (FIG. 1) in any number of different manners, including, but not limited to, directly welded to the truck 102, and bolted directly to the truck 102. In one embodiment, the hitch 200 includes a framework that securely connects the hitch 200 with the truck 102 frame, and enables fine positioning of the hitch 200. The framework 208 may comprise a tubular frame as depicted, or alternatively be formed of solid plates of material, bar stock, angle-iron, or the like.

The hitch 200 may also include a lever 210 configured to release the kingpin 206 from the hitch 200. For example, the lever 210 may be configured to open the jaw mechanism (not shown here) in order to release the kingpin 206. In a further embodiment, the hitch 200 includes a ramp 212. The ramp 212 is preferably a pivotally connected member disposed toward the front side of the hitch 200. The ramp 212 is in one embodiment configured to pivot to a lower position as the kingpin 206 slides across the ramp 212 during the hitching process.

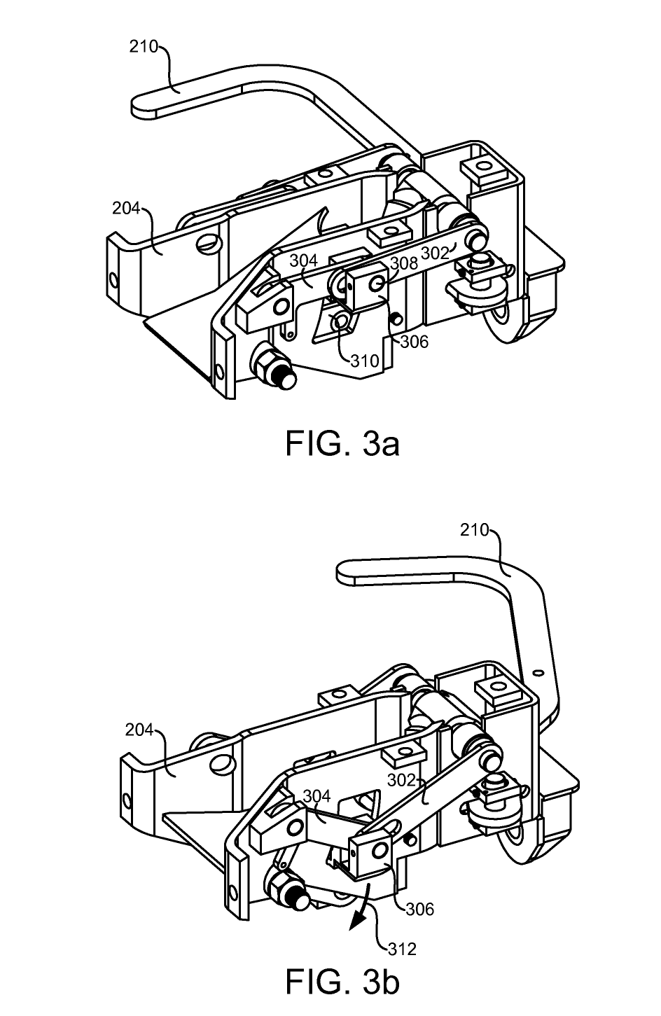

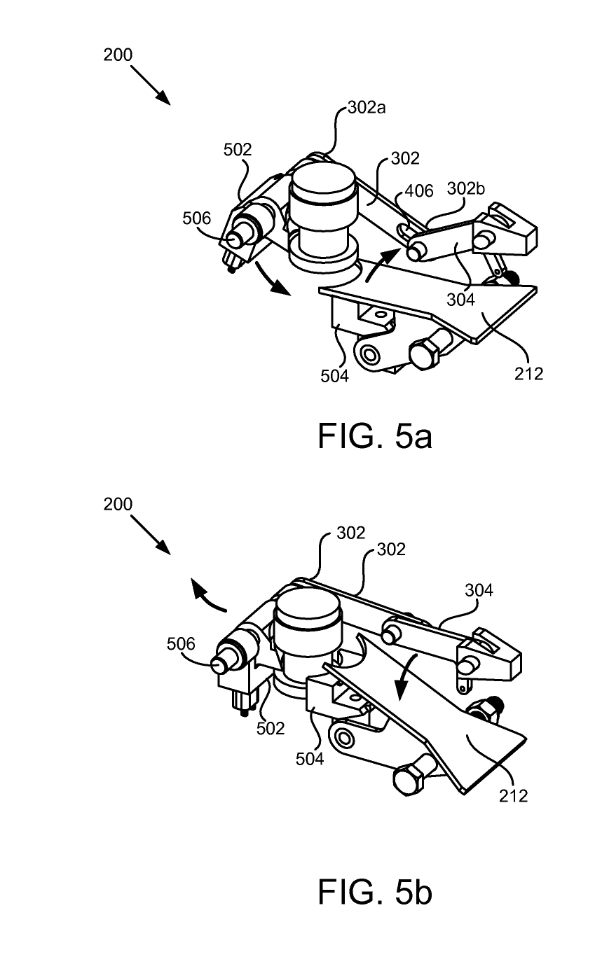

FIGS. 3a and 3b are a perspective views illustrating one embodiment of the internal components of the hitch 200 of FIG. 2 in accordance with the present invention. In one embodiment, a cup 504 (shown in FIG. 5) and a locking extension 502 (also shown in FIG. 5) are coupled with a linkage. In one embodiment, the ramp may is also connected through the linkage to the cup and the locking extension.

While the linkage may be any suitable connecting mechanism, in the depicted example, the hitch 200 includes a plurality of linkage bars 302, 304 that connect a locking extension 502 and the cup 504. A block 306 having a pin 308 couples the linkage bars 302, 304 together. A slot 310 formed in the shroud 204 is configured to receive the block 306. Furthermore, the slot 310 is formed substantially in the shape of an arc of a circle that is defined by the movement of the bars 302,304. Subsequently, the block 306 follows the path of the slot 310. As used herein, the term “arc” refers to a portion of the circumference of a circle or other curved planar shape.

In FIG. 3a, the lever 210 is shown in a closed position which may also be referred to as a latched position. As used herein, the term “closed position” refers to the position of the locking extension 502 and the cup 504, and more specifically refers to a closed or locked position in which the coupling member is locked to the hitch. In FIG. 3b, the lever 210 is shown in the open position. The term “open” or “open position” refers to a position in which the kingpin or coupling member is released. Furthermore, the term “open” may refer to a cup position and a locking extension position that are ready to receive the kingpin 206 of FIG. 2.

As used herein, the phrase “receiving the kingpin” refers to the operation of connecting a truck to a trailer. Typically when connecting to a trailer, the trailer is stationary and the driver of the truck backs the truck up to the trailer, carefully aligning the hitch with the kingpin of the trailer. The truck may be a pickup truck or alternatively a truck of the diesel semi type. Furthermore, the trailer may be of the fifth wheel type, a tractor trailer, or other similar arrangement.

In one embodiment, the block 306 is configured to move in a direction indicated by the arrow 312. The movement of the block 306 causes the bars 302, 304 to pivot and in turn pivot the locking extension 502 and the cup 504 (see FIGS. 5a-7).

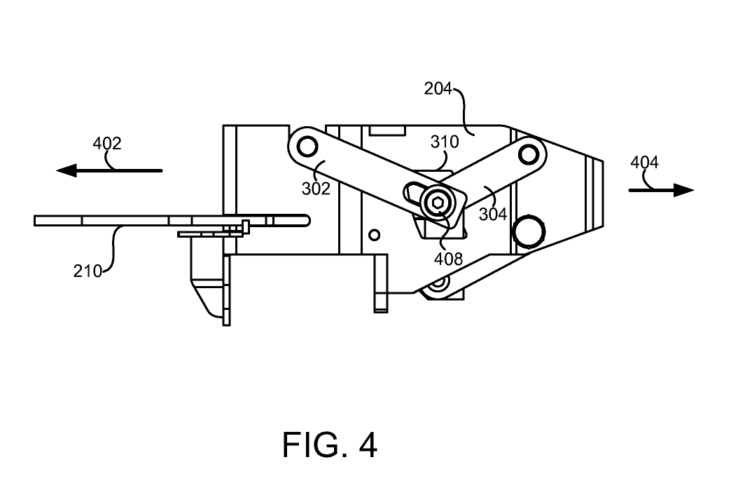

FIG. 4 is a side perspective view illustrating one embodiment of the shroud 204 in accordance with the present invention. In one embodiment, the shroud 204, and consequently the hitch 200, is positioned in the bed of a truck in a manner such that the lever 210 is closest to the cab of the truck. Arrow 402 indicates a direction towards the front of the truck, and arrow 404 indicates a direction towards the rear of the truck. As described above, the truck backs in a direction indicated by arrow 404 when connecting to a trailer.

In the depicted embodiment, the forward bar 302 is configured with a slot 310 that enables the downward sweeping motion as the block 306 slides in the slot 310. Alternatively, the block 306 may be replaced with a fastening mechanism such as a nut and bolt 408 as depicted in FIG. 4.

FIGS. 5a and 5b are perspective view s illustrating a partial view of the hitch 200 in accordance with the present invention. The hitch 200, as described above, comprises the ramp 212, bars 302, 304, the locking extension 502, and the cup 504. The term “cup” refers to a mechanism that holds the coupling member in place. In the depicted embodiments, the cup is formed with an at least partially arcuate sidewall that is positionable to interface with a greater diameter portion of the coupling member to prevent horizontal coupling member movement. Of course, the cup need not be arcuate, if for instance, the coupling member is of a shape other than circular or cylindrical.

The locking extension 502 is also a mechanism that holds the coupling member in place. In the depicted embodiments, the locking extension 502 is positioned to oppose the cup and is positionable to interface with a lesser diameter portion of the coupling member to prevent vertical movement of the coupling member.

In one embodiment, an axle 506 is fixedly coupled with the locking extension 502. For example, the axle 506 may be welded or otherwise attached to the locking extension 502 such that the axle rotates with the pivoting of the locking extension 502.

In one embodiment, the bar 302, at a first end 302a is fixedly connected with the axle 506 such that a rotating axle 506 causes the bar 302 to pivot about the axle 506. A second end 302b of the bar 302 is slidably connected with the bar 304. The slot 406 enables both bars 302, 304 to move in their respective arcs while maintaining the coupling of the bars 302, 304.

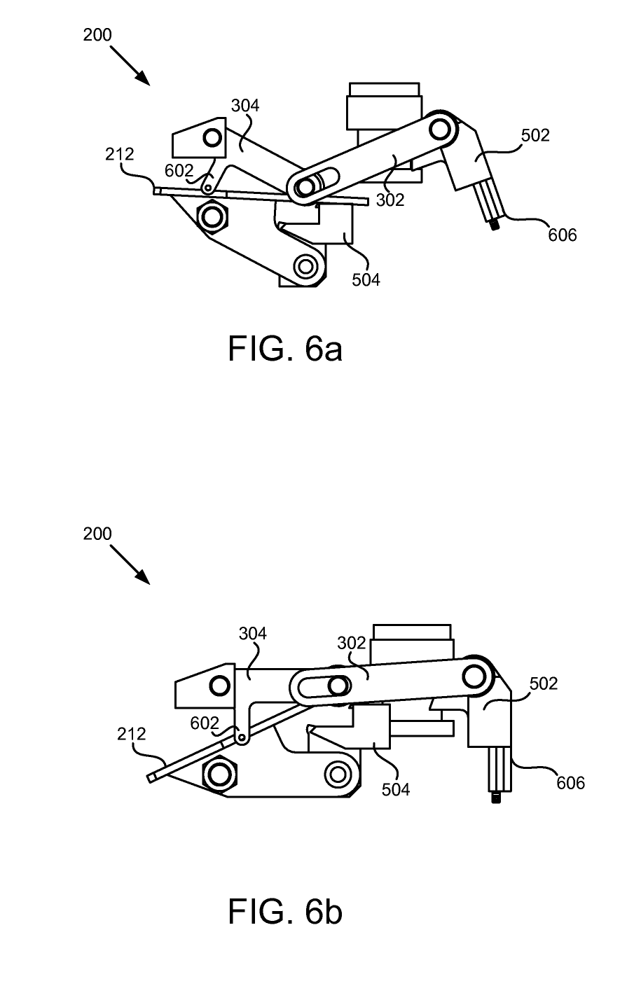

FIGS. 6a and 6b are schematic block diagrams illustrating an alternative partial view of the hitch 200 in accordance with the present invention. In one embodiment, the bar 304 includes a downwardly extending portion 602 that may comprise a spring lever configured to return the ramp 212 to the closed position. FIG. 6a illustrates an “open” or unlatched configuration with the ramp 212 pivoted downward and the locking extension 502 pivoted outward. Similarly, FIG. 6b illustrates the “closed” configuration.

In a further embodiment, the locking extension 502 includes a downwardly extending rod 606 for interfacing with the lever 210. The rod 606 is configured to engage an opening in the lever 210 (FIG. 2) and subsequently transfer motion of the lever 210 through the hitch 200. For example, pulling on the lever 210 towards the front of the truck causes the locking extension 502 to pivot outward, or toward the front of the truck. This pivoting motion causes the axle 506 to also rotate, which in turn pivots the bar 302 downward towards the truck bed.

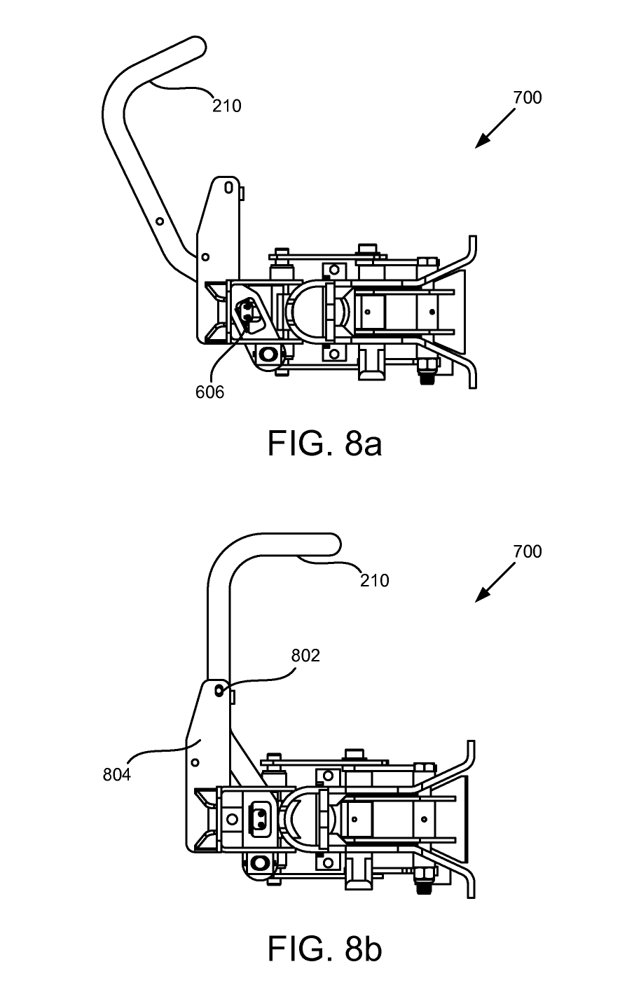

Likewise, the bar 304 is forced to pivot downward and cause the ramp 212 to pivot downward, thereby completing the “opening” of the hitch. The interaction of the lever 210 and the locking extension 502 will be discussed below with reference to FIGS. 8a and 8b.

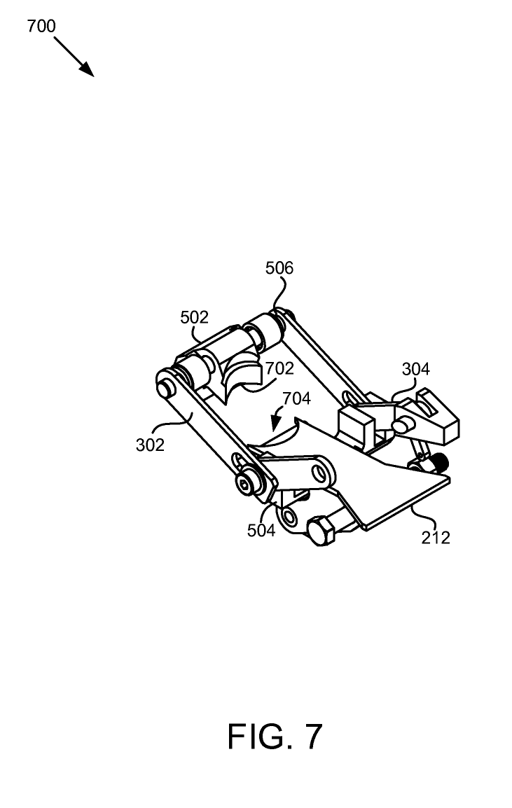

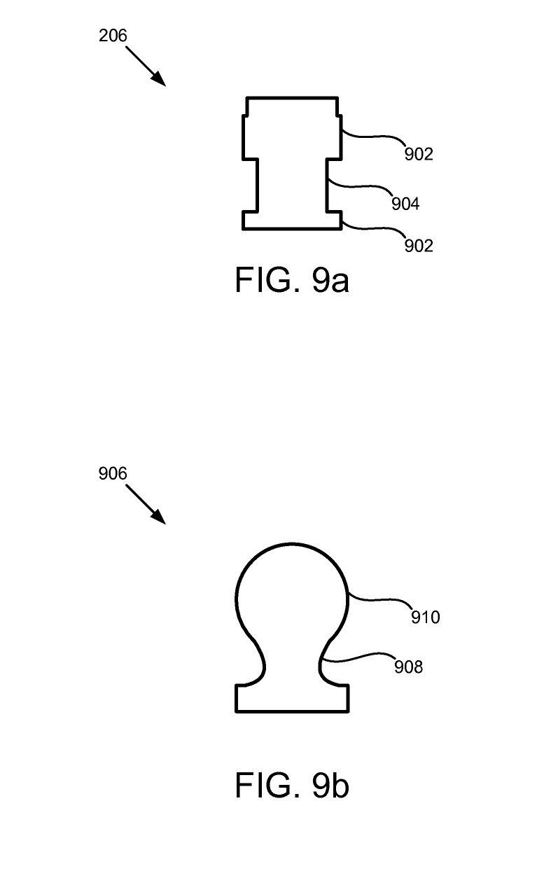

FIG. 7 is a perspective view illustrating one embodiment of a jaw mechanism 700 in accordance with the present invention. In one embodiment, the jaw mechanism 700 includes the above described components including the ramp 212, bars 302, 304, and axle 506. The locking extension 502 may comprise a lip 702 having a semi-circular cutout for engaging the cylindrical kingpin 206. As depicted, the lip 702 is chamfered with an angle to allow the locking extension 502 to rotate away from the kingpin (not shown) in order to release the kingpin. When in a “closed” position, the lip 702 of the locking extension 502 engages the shank of the kingpin (See FIG. 9a) and prevents vertical movement of the kingpin and subsequently the trailer.

Similarly, the ramp 212 and the cup 504 may comprise a semi-circular cutout 704 for engaging the head (See FIG. 9a) of kingpin 206. The cup 504 together with the ramp 212 prevent horizontal or lateral movement of the kingpin 206 when in a closed position.

FIGS. 8a and 8b are bottom perspective views illustrating embodiments of the interaction of the locking extension 502 with the lever 210 in accordance with the present invention. As illustrated, the rod 606 engages an opening in the lever 210 in order to allow the lever 210 to open and close the jaw mechanism, as depicted in FIG. 7. FIG. 8a depicts an extended or open position. The opening in the lever 210 is configured to enable the semi-circular movement of the lever to be translated into the lateral pivoting of the locking extension 502.

In a further embodiment, the lever 210 may comprise a safety mechanism 802. The safety mechanism 802 may comprise a protruding tab that locks into a support plate 804 that extends outward from the shroud 204. Examples of safety mechanisms 802 that may be utilized with the present invention include, but are not limited to, pins, locks, bolts, etc. Such safety mechanism may be utilized in maintaining the jaw mechanism in an open position.

FIG. 9a is a schematic block diagram illustrating one embodiment of a cross section of a coupling member in accordance with the present invention. In the depicted example, the coupling member is a kingpin 206. As depicted, the kingpin 206 is formed with a larger diameter portion 902 and a smaller diameter portion 904. The kingpin 206 is typically fixedly coupled with a trailer as described above with reference to FIG. 1. The larger diameter portion 902, is often referred to as the “head” of the kingpin, and the smaller diameter portion 904 is known as the “shank.” Trailers are connected with the end of the kingpin 206 opposite the larger diameter portion 902.

FIG. 9b is a cross-sectional view illustrating a further embodiment of a coupling member in accordance with the present invention. In the depicted example, the coupling member is ball hitch 906. The ball hitch 906 is formed with a smaller diameter portion 908 and a larger diameter portion 910. The smaller diameter portion 910 may be referred to as the “shank” of the ball hitch, with the larger diameter portion 908 being referred to as the “ball.”

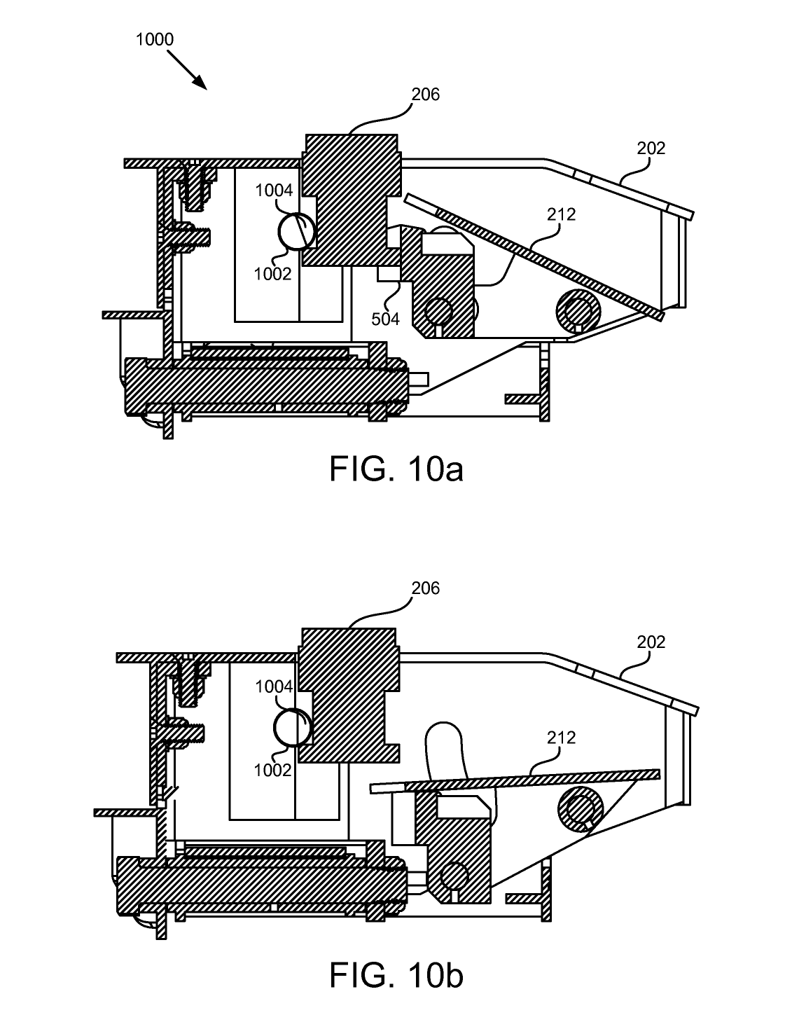

FIG. 10a is a cross-sectional view illustrating an alternative embodiment of a hitch 1000 in accordance with the present invention. In one embodiment, the hitch 1000 comprises the cover 202, the ramp 212, and the cup 504 as described above with reference to FIGS. 2-8b. The hitch 1000, in this embodiment, comprises a locking extension that is implemented in the form of a cam 1002. The cam 1002 is rotatable and configured to engage the smaller diameter portion of the kingpin 206. Alternatively, the cam 1002 may be configured to engage the smaller diameter portion of a ball hitch 906.

As depicted, the cam 1002 is formed with a surface formed having a cutout portion 1004 configured to enable the kingpin 206 to be raised. FIG. 10a illustrates the cam 1002 in a “closed” position that prevents vertical kingpin 206 movement. In this position, the cutout portion 1004 is not aligned with the greater diameter bottom portion of the kingpin 2006 in a manner that would allow movement. Consequently, the kingpin 206 is held securely in place between the cam 1002 and the cup 504.

FIG. 10b is a cross-sectional view illustrating another embodiment of the hitch 1000 in accordance with the present invention. In the depicted embodiment, the cam 1002 is positioned in an “open” position, with the cutout 1004 in a substantially vertical orientation such that the kingpin head may pass. When in the open position, the greater diameter bottom portion of the kingpin 206 is allowed to pass through the cutout portion 1004 of the cam 1002.

The cam 1002 is in this embodiment coupled through a linkage with the cup 504 and ramp 212 such that downward pivotal movement of the ramp 212 causes the cam 1002 to rotate from the closed position of FIG. 10a to the open position of FIG. 10b.

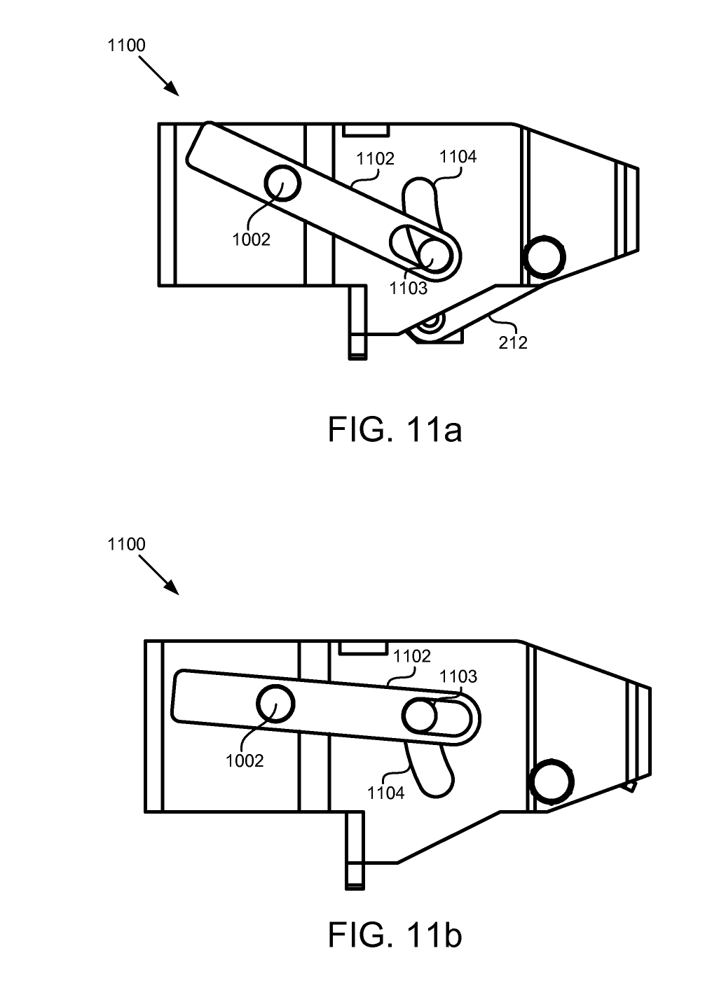

FIGS. 11a and 11b are side views illustrating alternative embodiments of the shroud 1100 in accordance with the present invention. The shroud 1100, as described above, provides a rigid structure for housing the ramp 212, the cup, and the locking extension (not shown here). In the embodiment of FIGS. 11a and 11b, a single bar 1102 couples the ramp with the cam 1002. The bar 1102 may be fixedly coupled with the cam 1002 and slidably coupled with a pin 1103 extending from the ramp 212. The pin 1103 is configured to engage a slot 1104 in the shroud 1100 and follow the path defined by the slot. As such, the pivotal movement of the ramp 212 is likewise defined by the movement of the pin 1106.

The upward and downward movement of the pin 1103 is translated by the bar into rotational movement of the cam 1002. In a downward position, as depicted in FIG. 11a, the cam 1002 is in an open position whereby a kingpin may be loaded or unloaded from the hitch. As the ramp 212 moves upward towards a “closed” position, as depicted in FIG. 11b, the cam 1002 rotates such that the cutout portion is rotated away from the kingpin and thereby vertical movement is prevented. The cup of FIGS. 11a and 11b functions in a manner similar to the cup 504 of FIGS. 5a and 5b in that the cup engages the head or larger diameter portion of the kingpin in order to prevent horizontal movement.

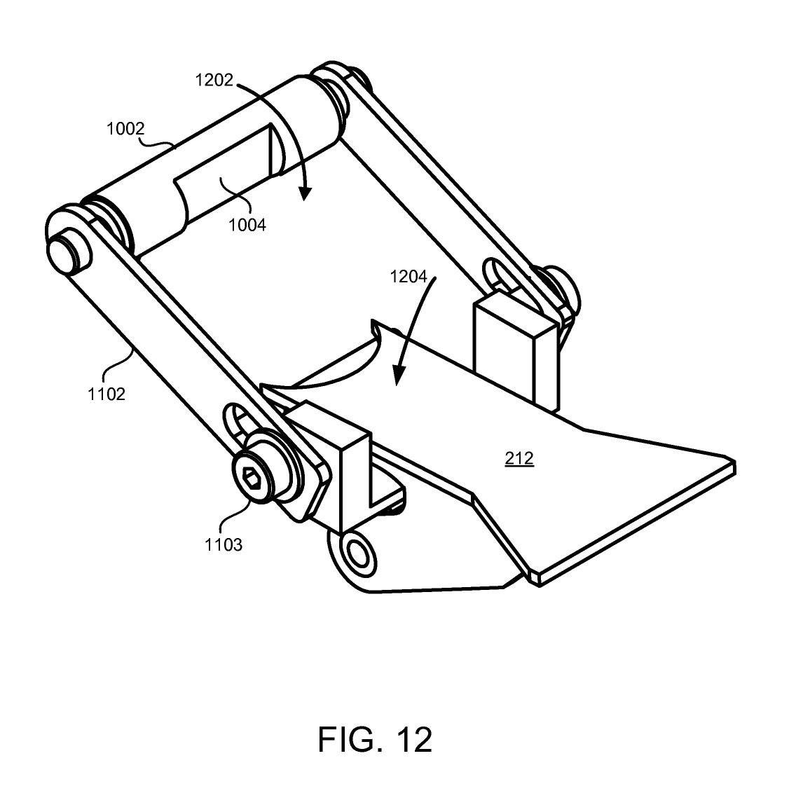

FIG. 12 is a perspective view illustrating one embodiment of the cam, the linkage, and the cup in accordance with the present invention. FIG. 12 illustrates only the moving parts of the hitch 1000 as described above with reference to FIGS. 10a-11b. The cam 1002 comprises a cutout portion 1004 configured with dimensions selected to allow the larger diameter portion of a kingpin 206 or a ball hitch 906 to pass. The cutout 1004 may be substantially rectangular as depicted, or alternatively, the cutout 1004 may have a more circular shape. An arrow 1202 illustrates the direction of rotation as the cam 1002 moves from a closed position to an open position in response to downward movement by the ramp as indicated by an arrow 1204.

The schematic flow chart diagram that follows is generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

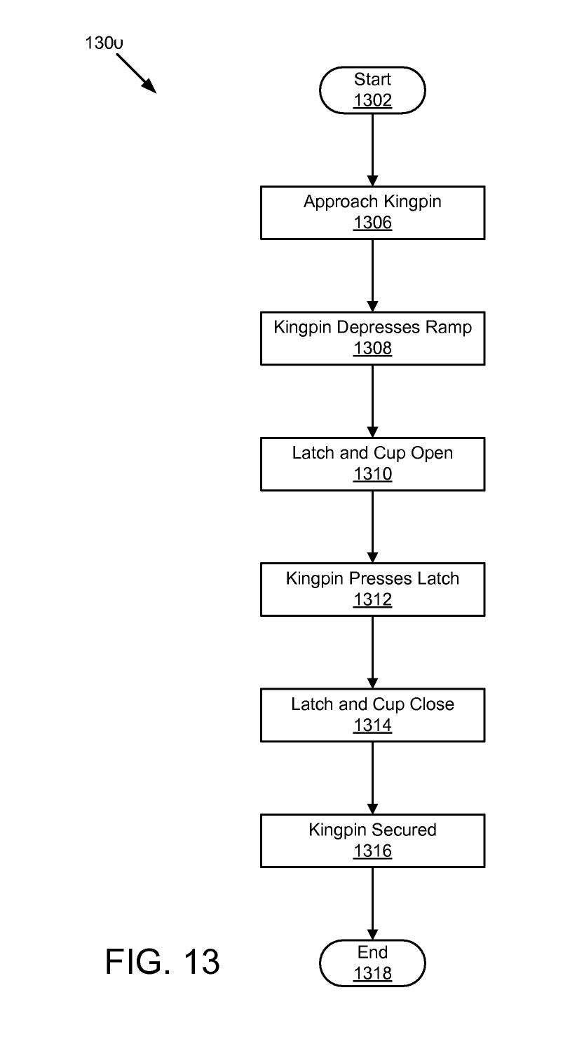

FIG. 13 is a schematic flow chart diagram illustrating one embodiment of a method 1300 for operating the hitch in accordance with the present invention. One benefit of the present invention is the ability to connect a truck to a trailer without the operator having to spend a significant amount of time getting the hitch to an exact height. The method 1300 also allows for the loading and unloading of the trailer in a manner that minimizes improper loading and accidents during trailer latching.

The method 1300 starts 1302 with the operator backing the truck up and approaching 1306 the kingpin. The lever 210 is preferably in the locked position for loading. The kingpin 206 contacts and depresses 1308 the ramp 212. As described above, depressing 1308 the ramp 212 causes the bar 304 to rotate downward which subsequently forces the bar 302 downward and simultaneously causes the locking extension 502 to rotate outward to an open 1310 position. Alternatively, in the embodiment of FIG. 12, the ramp 212 may cause the bar 1102 to rotate the cam 1002. Conversely, if the kingpin 206 approaches the hitch in a vertical or substantially vertical direction, the kingpin 206 will depress the locking extension. The locking extension subsequently causes the cup to rotate to an open position before locking into a secure position around the kingpin. Thus the trailer is capable of being hitched vertically or horizontally, a feat not currently possible with prior art fifth wheel hitches.

As the driver continues to “close in” on the kingpin, the kingpin 206 presses 1312 on the locking extension 502. Upon reaching a certain pressure threshold from the kingpin 206 pressing on the locking extension 502 or passing the ramp 212, the cup and locking extension close and secure 1316 the kingpin 206. This also causes the lever 210 to move to the locked position. At this point the method 1300 ends 1318.

When the operator desires to unhitch the trailer, he/she moves the lever 210 to the open position and drives the truck forward out of engagement with the hitch. The lever 210 should then be returned to the locked position for future loading of the trailer onto the hitch.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A hitch comprising:
a locking extension positionable to interface with a lesser diameter portion of a coupling member to prevent vertical movement of the coupling member;
a cup positionable to interface with a greater diameter portion of the coupling member to prevent horizontal coupling member movement; and
a linkage coordinating relative movement of the locking extension and the cup such that the coupling member is receivable into lockable engagement with the hitch upon either vertical or horizontal movement of the coupling member relative to the hitch.

2. The hitch of claim 1, further comprising a ramp pivotally connected to the hitch and connected with the cup.

3. The hitch of claim 2, wherein the ramp is connected to the locking extension with a linkage such that depressing the ramp causes the locking extension to rotate to an open position.

4. The hitch of claim 2, wherein the linkage comprises a bar coupled with the ramp and configured to transfer pivotal movement of the ramp with the locking extension.

5. The hitch of claim 1, further comprising a handle coupled with the locking extension and configured to release the coupling member.

6. The hitch of claim 1, wherein the cup comprises comprising an at least partially arcuate sidewall for receiving a greater diameter portion of the coupling member.

7. The hitch of claim 1, wherein the locking extension comprises a cam having a cutout portion.

8. The hitch of claim 7, wherein the cam is rotatably mounted to the hitch such that when the hitch is configured in an open position, the coupling member is allowed to pass through the cutout portion, and when the hitch is configured in a closed position, the cam is rotated to a position in which the coupling member is unable to pass through the cutout portion.

9. The hitch of claim 1, wherein the coupling member is a kingpin.

10. The hitch of claim 1, further comprising an outer shroud, and wherein the cup and the locking extension are connected with the shroud.

11. The hitch of claim 1, wherein the larger diameter portion of the trailer coupling member is a ball of a ball hitch.

12. The hitch of claim 1, wherein the cup and locking extension are configurable in a closed position in which the coupling member is secured to the hitch.

13. The hitch of claim 1, wherein the cup and locking extension are configurable in an open position in which the coupling member is released from the hitch.

14. The hitch of claim 1, wherein the cup and locking extension are configurable in an open position in which the coupling member is released from the hitch and a closed position in which the locking extension and the cup are configured to secure the coupling member and prevent horizontal and vertical coupling member movement with respect to the hitch.

15. A system for horizontal and vertical trailer latching, the system comprising:
a trailer having connected thereto a coupling member for connecting with a hitch; and
a vehicle having a hitch configured to couple with the coupling member, the hitch comprising:
a locking extension positionable to interface with a lesser diameter portion of a coupling member to prevent vertical movement of the coupling member;
a cup comprising an at least partially arcuate sidewall positionable to interface with a greater diameter portion of the coupling member to prevent horizontal coupling member movement; and
a linkage coordinating relative movement of the locking extension and the cup such that the coupling member is receivable into lockable engagement with the hitch upon either vertical or horizontal movement of the coupling member relative to the hitch.

16. The system of claim 15, further comprising a ramp pivotally connected to the hitch and connected with the cup.

17. The system of claim 16, further comprising a bar coupled with the ramp and configured to transfer pivotal movement of the ramp with the locking extension.

18. The system of claim 15, further comprising a handle coupled with the locking extension and configured to release the coupling member.

19. The system of claim 15, wherein the cup comprises comprising an at least partially arcuate sidewall for receiving a greater diameter portion of the coupling member.

20. The system of claim 15, wherein the locking extension comprises a cam having a cutout portion, the cam rotatably mounted to the hitch such that when the hitch is configured in an open position, the coupling member is allowed to pass through the cutout portion, and when the hitch is configured in a closed position, the cam is rotated to a position in which the coupling member is unable to pass through the cutout portion.

21. The system of claim 15, wherein the coupling member comprises a kingpin.

22. The system of claim 15, wherein the larger diameter potion of the coupling member comprises a head of a kingpin.

23. A method for horizontal and vertical trailer latching, the method comprising:
positioning and interfacing a locking extension with a lesser diameter portion of a coupling member to prevent vertical movement of the coupling member;
positioning a cup comprising an at least partially arcuate sidewall and to interfacing with a greater diameter portion of the coupling member to prevent horizontal coupling member movement; and
coordinating relative movement of the locking extension and the cup such that the coupling member is receivable into lockable engagement with the hitch upon either vertical or horizontal movement of the coupling member relative to the hitch.

24. The method of claim 23, further comprising pivoting a ramp coupled with the cup to transition the hitch from an open position to a closed position.

25. The method of claim 24, further comprising coordinating movement of the ramp and the cup with movement of the locking extension.

26. The method of claim 25, wherein the ramp pivots upon application of pressure on the ramp by a coupling member.

27. The method of claim 23, further comprising contacting the coupling member with the ramp to depress the ramp and in response cause the locking extension to rotate to an open position and cause the cup to rotate to an open position.

28. The method of claim 23, further comprising reaching a certain pressure threshold of the coupling member pressing on the locking extension and in response, causing the cup and locking extension close and secure coupling member.
